(19) United States
(12) Patent Application Publication
(10) Pub. No.: US 2017/0337626 A1
(43) Pub. Date: Nov. 23, 2017

(54) Systems and Methods for Use in Offering Accounts to Consumers Based on Locations of the Consumers

(71) Applicant: MASTERCARD INTERNATIONAL INCORPORATED, Purchase, NY (US)

(72) Inventors: Dexter Bryant, White Plains, NY (US); Christopher T. Scholl, Hazelwood, MO (US)

(21) Appl. No.: 15/158,765

(22) Filed: May 19, 2016

(51) Int. Cl. G06Q 40/02; G06Q 20/40; G06Q 20/24

(52) U.S. Cl. CPC G06Q 40/025; G06Q 20/24; G06Q 20/40145

(57) ABSTRACT

Systems and methods are provided for use in offering credit accounts to consumers based on the consumers being at locations of merchants associated with the credit accounts. One exemplary method includes detecting, by a computing device, a location associated with a merchant and transmitting the detected location to a credit offer engine. The method also includes receiving, by the computing device, a credit account offer associated with the merchant, based on the detected location, and receiving an acceptance from the consumer in response to the offer. The method further includes transmitting, by the computing device, a credit application to the credit offer engine for a credit account associated with the offer and, upon approval of the credit application, receiving and appending credentials associated with the credit account to a payment application of the consumer, whereby the credit account is usable to fund a payment transaction with the merchant.

### FIELD

The present disclosure generally relates to systems and methods for use in offering merchant-specific accounts to consumers based on the consumers being at locations of merchants associated with the accounts.

### BACKGROUND

This section provides background information related to the present disclosure which is not necessarily prior art.

Payment accounts are known as a mechanism for consumers to fund purchases of products (e.g., goods and services, etc.). Payment accounts may be merchant generic, or merchant specific. For example, certain merchants may partner with issuers to offer payment accounts, and specifically, credit payment accounts, to their customers that are usable only at the merchants and thereby incentivize the customers to shop with the merchants. In order to obtain the offered payment accounts, customers must fill out payment account applications, return them to the merchants and/or issuers, and wait for acceptance. The payment accounts may be associated with payment devices in the form of cards, fobs, and/or electronic wallets (e-wallets, wearables), etc. Credit accounts are known to further include loan accounts (e.g., automobile loans, home loans, etc.). Separately, certain computing devices are known to determine and report locations of the devices to associated consumers, through use of a global positioning system (GPS) or other techniques reliant on one or more networks, or even to determine the presence of the computing devices within a specified region (e.g., via geo-fencing).

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in offering merchant-associated accounts to consumers based on the consumers' presence or entry to a region associated with the merchant;

FIG. 2 is a block diagram of a computing device that may be used in the exemplary system of FIG. 1;

FIG. 3 is an exemplary method, which may be implemented in connection with the system of FIG. 1, for offering a merchant-specific account to a consumer when the consumer is detected at the region associated with the merchant, and for subsequently issuing the merchant-specific account to the consumer; and

FIGS. 4-5 are exemplary interfaces associated with a communication device, which may be used in connection with the system of FIG. 1 and/or the method of FIG. 3 for offering a credit account to a consumer.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Merchants often offer credit cards to consumers to incentivize repeat business at the merchants. In addition, consumers often carry mobile phones and other communication devices that are capable of determining locations of the consumers with respect to nearby merchants, and that further may include payment applications, such as, for example, electronic wallet or e-wallet applications. Uniquely, the systems and methods herein permit merchants to offer new accounts to consumers, based on the consumers being at locations associated with the merchants. In particular, for example, a communication device associated with a consumer may provide a location of the consumer when disposed at the location of the merchant (e.g., when the device crosses and/or is within a geo-fence defining the merchant location, etc.). In response, an account offer engine causes an account offer to be made to the consumer, via the communication device. When the consumer accepts the offer, and provides an application (e.g., a credit application, etc.), the account offer engine then coordinates approval of the application and issuance of the new account to the consumer. In one example, the account is a credit payment account (although the present disclosure is not limited such an account), which is appended to a payment application included in the consumer's communication device promptly after issuance (e.g., the credit payment account is tokenized and inserted into an electronic wallet associated with the consumer's communication device, etc.). Importantly, through the systems and methods herein, the consumers may be offered the accounts, apply for the accounts, and receive the issued accounts within a predefined time sufficient, for example, for the consumers to do their shopping at the associated merchants, thereby often enabling the consumers to readily use the accounts while still present at the merchants.

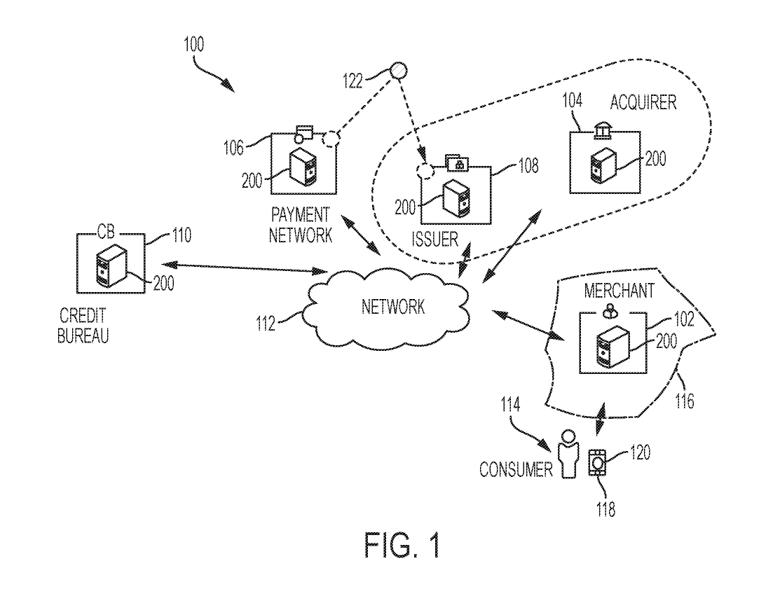

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, implementation of new account offers in the system 100, involvement of different parts of the system 100 with such new account offers, etc.

The system 100 generally includes a merchant 102, an acquirer 104, a payment network 106, an issuer 108, and a credit bureau 110, each coupled to and in communication with network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 112 may include multiple different networks, such as a private payment transaction network made accessible by the payment network 106 to the merchant 102, acquirer 104, and issuer 108, and, separately, the public Internet, which may be accessible to the credit bureau 110, a consumer 114, and any other parts of the system 100, etc. as desired.

Generally, the merchant 102 offers for sale and sells products (e.g., goods and services, etc.) to consumers, including, for example, consumer 114. As shown in FIG. 1, the merchant 102 is associated with a location 116 (e.g., a region, etc.). The location 116 may define a physical structure of the merchant 102 (e.g., a building, store, property, etc.) and/or a broader property of the merchant 102 (e.g., extending to a parking lot, etc.) In one example, the location 116 is defined by one or more “geo-fences” (e.g., as defined by cellular triangulation, Wi-Fi ID, GPS, etc.), that geographically define boundaries of the location 116. In addition, the location 116 may be a variety of different sizes (e.g., the size of the merchant 102, the size of a department in merchant 102, the size of the block on which merchant 102 is located, etc.). Further, the location 116 may be associated with only one site, or with multiple different sites of the merchant 102 (e.g., different sites of a chain merchant within a city, etc.). Moreover, the boundary or boundaries of the location 116 may be delineated by geographic coordinates (e.g., by latitude and longitude, etc.) or by reference to another characteristic detectable by the communication device 118 (e.g., a Wi-Fi router, a radio frequency identification (RFID) device, or the like, etc.).

The credit bureau 110 is configured to provide one or more scores, or other indicators, of consumers' qualifications for one or more payment accounts. For example, in the system 100, the credit bureau 110 is configured to provide credit reports for consumers, based at least in part on financial behaviors of consumers, of trustworthiness of the consumers for the purposes of offering the consumers new accounts associated with credit, or the like (e.g., payment accounts, loan accounts, insurance accounts, rental accounts, bank accounts, medical accounts, etc.). The financial behaviors may include, for example, amounts of debt, amounts of credit, payment history, credit inquiries, length of credit history, etc. The credit bureau 110 is also configured to, upon receiving an inquiry related to a consumer (e.g., the consumer 114, etc.), generate and return a credit report, often including a score or other indicator, to the requesting entity, such as, for example, the issuer 108 in connection with issuing a payment account to the consumer 114 for merchant 102, etc. While the credit bureau 110 is included in the system 100 to provide indicators of the consumers' qualifications for payment accounts, it should be appreciated that in some embodiments issuers associated with the new accounts (e.g., issuer 108 in the system 100, etc.) may, alternatively, provide the indicators of the consumer's qualifications for the payment accounts (instead of the credit bureau 100).

Also in the system 100, the consumer 114 is in possession of a communication device 118 that is also coupled to the network 112. The communication device 118 can be generally understood to be a portable communication device such as, for example, a mobile phone, a personal digital assistant (PDA), a tablet, a laptop, or other computing device suitable to be portable and/or carried by the consumer 114, etc. (although this is not required in all embodiments). The communication device 118, in this exemplary embodiment, includes a payment application such as, for example, an electronic wallet (or e-wallet) application (e.g., a virtual wallet application, etc.) (e.g., MasterPass®, Apple Pay®, Samsung Pay®, PayPal®, Google Wallet®, Android Wallet™, etc.), which configures the communication device 118 to act as a payment device, for and/or with one or more different payment accounts.

As an example, when the consumer 114 intends to make a purchase at the merchant 102, funded by a payment account in the consumer's e-wallet application, the consumer 114 presents the communication device 118 to the merchant 102, and in particular, a point of sale (POS) terminal (not shown) of the merchant 102. In turn, the merchant 102 (and particularly the POS terminal) reads payment account information from the communication device 118 for a desired account (e.g., an account in the e-wallet application specified by the consumer 114, an account in the e-wallet application associated with the merchant 102, etc.). The communication device 118 may communicate the payment account information to the POS terminal in any desired manner including, for example, via near field communication (NFC) devices, barcodes, other signals and/or indicia representative of the payment account information, etc.

In turn in the above example, the merchant 102 submits an authorization request to the acquirer 104 (associated with the merchant 102) for the transaction (and including the payment account information provided by the communication device 118), to determine whether the payment account is in good standing and whether there is sufficient funds and/or credit to fund the transaction. To accomplish this, the acquirer 104 communicates the authorization request with the issuer 108 (associated with the consumer's payment account), through the payment network 106, such as, for example, through MasterCard®, VISA®, Discover®, American Express®, etc. In turn, if approved, an authorization reply, or response (indicating the approval of the transaction), is transmitted back from the issuer 108 to the merchant 102, thereby permitting the merchant 102 to complete the transaction. The transaction is later cleared and/or settled (via appropriate transaction messages such as clearing messages and/or settlement messages, for example) by and between the merchant 102, the acquirer 104, and the issuer 108 (by appropriate agreements). If the acquirer 104 and issuer 108 are the same entity, which is possible, as indicated by the dotted lines in FIG. 1, the clearance and settlement of the transaction may be simplified. If the transaction is declined, however, an authorization reply (indicating a decline of the transaction) is provided back to the merchant 102, thereby permitting the merchant 102 to halt or terminate the transaction, or request alternate funding.

While the above transaction is described in connection with a payment application, it should be appreciated that other payment devices may be similarly used to initiate transactions (e.g., payment card, fobs, wearable devices, etc.).

Transaction data is generated, collected, and stored as part of the above interactions among the merchant 102, the acquirer 104, the payment network 106, the issuer 108, and the consumer 114. The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106, etc.). Additionally, or alternatively, the acquirer 104 and/or the issuer 108 may report payment account information and/or transaction data, or processed versions thereof, as well as account balances, account payments, etc. to the credit bureau 110 (for use in compiling credit reports, etc.). As used herein, transaction data may include, for example (and without limitation), primary account numbers (PANs) for consumers involved in the transactions, amounts of the transactions, merchant IDs for merchants involved in the transactions, merchant category codes (MCCs), balances, payment history dates/times of the transactions/payments, incentives used (e.g., rebates discounts, etc.), etc. It should be appreciated that more or less information related to transactions, as part of either authorization or clearing and/or settling, may be included in transaction records and stored within the system 100, at the merchant 102, the acquirer 104, the payment network 106 and/or the issuer 108.

In various exemplary embodiments, consumers (e.g., consumer 114, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions herein, subsequently for one or more of the different purposes described herein.

While one merchant 102, one acquirer 104, one payment network 106, one issuer 108, one credit bureau 110, and one consumer 114 are illustrated in FIG. 1, it should be appreciated that any number of these parts (and their associated components) may be included in the system 100, or may be included as a part of systems in other embodiments, consistent with the present disclosure.

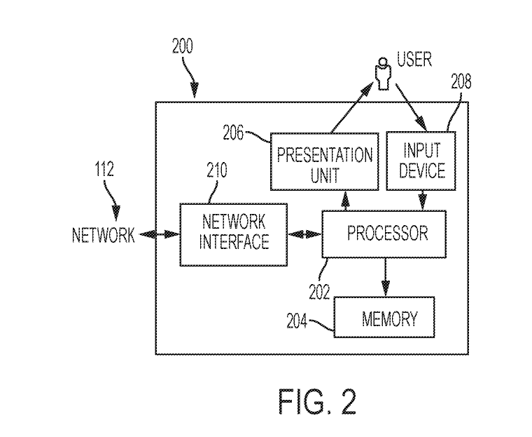

FIG. 2 illustrates an exemplary computing device 200 that can be used in the system 100. The computing device 200 may include, for example, one or more servers, workstations, personal computers, laptops, tablets, smartphones, POS terminals, PDAs, etc. In addition, the computing device 200 may include a single computing device, or it may include multiple computing devices located in close proximity or distributed over a geographic region, so long as the computing devices are configured to function as described herein. However, the system 100 should not be considered to be limited to the computing device 200, as described below, as different computing devices and/or arrangements of computing devices may be used. In addition, different components and/or arrangements of components may be used in other computing devices. In the system 100, shown in FIG. 1, the merchant 102, acquirer 104, payment network 106, issuer 108, and credit bureau 110 are illustrated as including, or being implemented in, computing device 200, coupled to the network 112. In addition, the communication device 118 associated with the consumer 114 may be considered a computing device consistent with computing device 200.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, credit offer information, account information, consumer profiles, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 also includes a presentation unit 206 that is coupled to (and in communication with) the processor 202 (however, it should be appreciated that the computing device 200 could include output devices other than the presentation unit 206, etc.). The presentation unit 206 outputs information (e.g., credit account offer interfaces, etc.), visually, for example, to a user of the computing device 200 such as, for example, the consumer 114 and/or users associated with one or more of the merchant 102, acquirer 104, payment network 106, issuer 108 and/or the credit bureau 110, etc. Various interfaces (e.g., as defined by internet-based applications, websites, etc.) may be displayed at computing device 200, and in particular at presentation unit 206, to display and/or solicit certain information, as described herein. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

In addition, the computing device 200 includes an input device 208 that receives inputs from the user (i.e., user inputs) such as, for example, contact information, social security number, other personal and/or account details, etc. The input device 208 is coupled to (and in communication with) the processor 202 and may include, for example, one or more of a keyboard, a pointing device, a mouse, a stylus, a card reader, a camera, a touch sensitive panel (e.g., a touch pad or a touch screen, etc.), a biometric input device (for reading biometric data such as fingerprints, eye scans, etc.), and/or other suitable input device. Further, in various exemplary embodiments, a touch screen may behave as both a presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 112. For example, the network interface 210 may include adapters/antennas, for use with cellular networks, Wi-Fi networks, near field communication (NFC) networks, Bluetooth networks, RFID networks, global positioning system (GPS) networks, etc. Further, in some exemplary embodiments, the computing device 200 includes the processor 202 and one or more network interfaces incorporated into or with the processor 202.

Referring again to FIG. 1, the communication device 118 associated with the consumer 114 in the system 100 is configured, by an offer interface engine 120, to operate as described herein. In this exemplary embodiment, the offer interface engine 120 is incorporated in the payment application of the communication device 118, but may be a standalone application and/or incorporated in one or more other applications, in the communication device 118, in other embodiments. Additionally, the system 100 includes a credit offer engine 122 defined by computer-executable instructions, which cause the computing device (e.g., computing device 200, etc.) to cooperate with the offer interface engine 120, to operate as described herein. The credit offer engine 122 may be incorporated with either the payment network 106 or the issuer 108, as illustrated by the dotted lines in FIG. 1, or in a stand-alone computing device or incorporated with one or more service providers (not shown) associated with the merchant 102, the issuer 108, or other entity shown (or not shown) in FIG. 1, etc.

In particular, for example, upon the consumer 114 entering the merchant location 116, the communication device 118 also enters the location 116. The communication device 118 is configured, by the offer interface engine 120, to detect its location at the merchant location 116 and transmit the detected location to the credit offer engine 122. The credit offer engine 122 is configured to, in response to the detected location, identify an offer for an account (e.g., a credit account, etc.) associated with the merchant 102 and transmit the offer to the communication device 118. The communication device 118 is configured, by the offer interface engine 120, to display the offer to the consumer 114, whereupon the consumer 114 is able to accept or decline the offer. The communication device 118 is configured to, in response to an acceptance of the offer, solicit and/or retrieve from memory (e.g., memory 204) credit application content (e.g., populate content from a consumer profile, etc.) and send the content to the credit offer engine 122. The credit offer engine 122 is configured to evaluate the application and cause a request for a credit report from the credit bureau 110 for the consumer 114. The credit offer engine 122 is further configured to, when the application is approved, cause the account to be issued to the consumer 114 (directly, or via issuer 108 as associated with issuing the new account, etc.), and transmit credentials associated with the new account to the consumer's communication device 118 (e.g., in tokenized form, etc.). In turn, the communication device 118 is configured, by the offer interface engine 120 and/or the payment application, to append the account to the payment application of the communication device 118, for use by the consumer 114.

In connection with the consumer 114 accepting the offer at the communication device 118, the offer interface engine 120 (associated with the payment application) may interact with (and communicate with) the credit offer engine 122 using application program interfaces (APIs) to extract appropriate data, as needed for the application, from the payment application (or otherwise from memory 204) at the consumer's communication device 118 (e.g., within the payment application, outside the payment application, etc.) and transmit the data to the credit offer engine 122. The extracted data can then be used by the credit offer engine 122, as described above, in connection with facilitating and (when appropriate) approving the application for the consumer 114.

The above description is generally provided with reference to the offer interface engine 120 operating in conjunction with the payment application at the consumer's communication device 118 (already included at the communication device 118), and appending the new account thereto when approved. However, it should be appreciated that the offer interface engine 120 may be configured to operate apart from any payment application and, for example, push a notifications for an offer to the consumer 114 at the communication device 118 (when the communication device 118 is at the merchant location 116) and request the consumer 114 to configure/setup a payment application at the communication device 118 to use in connection with any new account issued to the consumer 114.

In one or more embodiments, the communication device 118 is configured, by the offer interface engine 120, to display one or more coupons, which relate to discounts, rebates, etc. at the merchant 102, based on the consumer's acceptance, or not, of the new account offer and/or the approval, or not, of the new account application. For example, the offer interface engine 120 may be configured to receive and present a coupon for the merchant 102 when the consumer 114 declines an offer for a new account or when the issuer 108 declines to issue the new account (e.g., based on the credit report from the credit bureau 110, etc.). Further, in one or more additional embodiments, the communication device 118 is configured to capture biometric data associated with the consumer 114, and is configured to utilize the biometric data to authenticate the consumer 114 as part of acceptance of the new account offer, submission of the application for the new account, and/or use of the new account.

In addition in the system 100, the offer interface engine 120 and/or the credit offer engine 122 may include one or more data structures for storing data related to the operations thereof. The data upon which the engines 120 and/or 122 operate may be/include any suitable information and may be stored in any suitable arrangement of data structures for use by the engines 120 and/or 122.

For example, the offer interface engine 120 may include a consumer profile data structure (not shown), in which certain information about the consumer 114 is included (e.g., name, mailing address, birth date, social security number, current employment, business address, income information, etc.). As such, the offer interface engine 120 may be configured to retrieve some or all content for the new account application from the consumer profile data structure. In addition (or alternatively), for example, the payment application of the communication device 118 associated with the consumer 114 and/or the offer interface engine 120 may include a payment application data structure (not shown), in which account information for the consumer 114 is stored. The offer interface engine 120 may then be configured to append the new account to the payment application data structure, so that the consumer 114 is able to utilize the new account in a subsequent transaction. Further, in another example, the credit offer engine 122 may include an offer data structure (not shown), in which different offers for different merchants (associated with merchant locations and/or identifiers), rules for making said offers, and merchant boundaries and/or locations are stored. For instance, boundaries of the merchant 102 may be stored in geographic coordinates or in a manner indicative of references available and associated with the merchant 102 (e.g., network signal strengths, etc.). The credit offer engine 122 may then be configured to identify a particular credit offer, in response to a detected location, in the offer data structure.

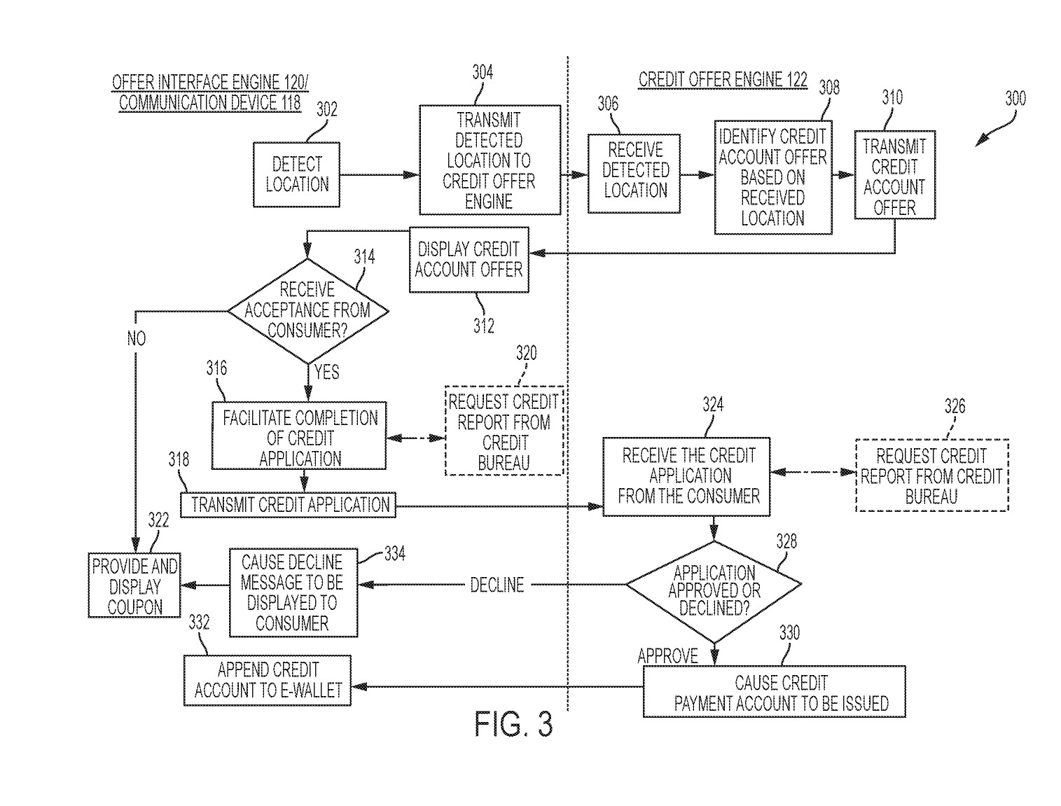

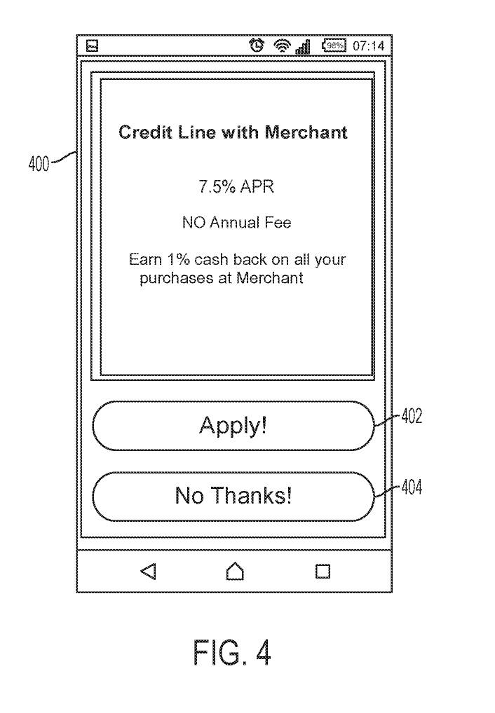

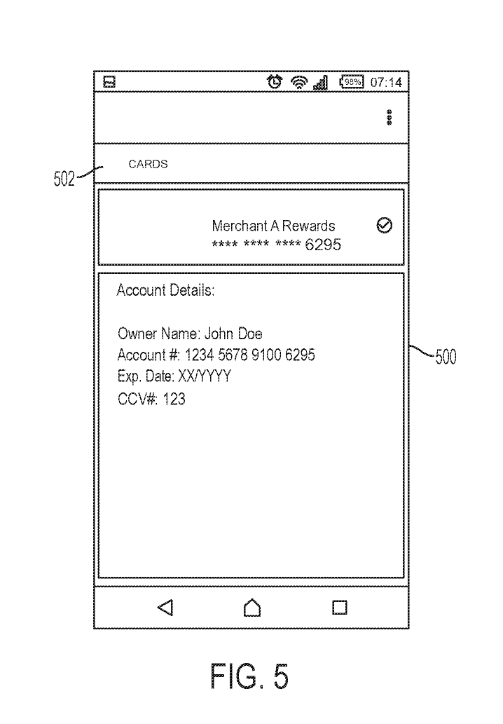

FIG. 3 illustrates an exemplary method 300 for use in offering a credit account to a consumer based on the presence of the consumer at a location associated with a merchant (e.g., the consumer entering and/or present at the location associated with the merchant, etc.). In this exemplary embodiment, the method 300 is described with reference to the consumer 114, the communication device 118, the offer interface engine 120, and the credit offer engine 122, and further with reference to the computing device 200. It should be appreciated, however, that the methods herein are not limited to these parts of the system 100 (or to the system 100 in general), or to the computing device 200, and that, conversely, the systems and computing devices herein are not limited to method 300. Further, the method 300 is described with reference to exemplary interfaces 400, 500, shown in FIGS. 4-5, respectively. The method 300, however, should not be understood to be limited the exemplary interfaces 400, 500, as other interfaces, or no interfaces, may be employed in methods described herein.

In the illustrated method 300, the communication device 114, as configured by the offer interface engine 120, detects its location, at 302, and transmits the detected location to the credit offer engine 122, at 304. Generally, the communication device 118 may detect its geographic location (e.g., the latitude and longitude of the communication device 118, etc.) or it may detect its location at the merchant location 116 (e.g., via network signal strengths, etc.). In addition, the communication device 118 may detect its location at regular, or irregular, intervals, or in response to an input and/or condition. In one example, the consumer 114 may provide an input to the communication device 118, and specifically to the offer interface engine 120, when entering or present at the merchant location 116. In another example, multiple merchants (e.g., including merchant 102, etc.) may include suitable emitting devices, at the associated location 116 (or locations), which emit a signal understood by the offer interface engine 120 (and the communication device 118). Upon detecting the signal (when the signal is generic to the merchants), the communication device 118 detects a geographic location and sends it to the credit offer engine 122. Alternatively, upon detecting a merchant specific signal, the communication device 118 may transmit its location based on the signal (without specifically detecting its geographic location) (i.e., transmit an identifier associated with the merchant 102 and known to the credit offer engine 122).

In turn, the credit offer engine 122 receives the detected location from the communication device 114, at 306. The credit offer engine 122 then identifies, at 308, a credit account offer based on the received location (e.g., the geographic location of the communication device 118, the detected merchant location 116, etc.). If the received location includes only the geographic location, in order to identify the credit account offer, the credit offer engine 122 first determines if the geographic location is associated with the merchant 102 (i.e., within the location 116 associated with the merchant 102, etc.). For example, the credit offer engine 122 may determine if the geographic location is within the location 116 as defined by a geo-fence associated with the merchant 102. If within the location 116, the credit offer engine 122 proceeds in identifying the credit account offer associated with the merchant 102. Conversely, if the received location indicates the merchant 102 (i.e., includes a merchant identifier), the credit offer engine 122 is able to directly identify the credit account offer associated with the merchant 102.

It should be appreciated that multiple different credit account offers may be available for selection (and even potentially identified) by the credit offer engine 112, based on the detected location of the communication device 118. In addition, it should be appreciated that the multiple different credit account offers may be associated with a single merchant (e.g., when the single merchant has multiple offerings for consumers, etc.), or they may be associated with multiple different merchants (e.g., when the communication device 118 is detected within a mall having multiple different merchants, etc.). As such, additional information, apart from the received location, may further be employed by the credit offer engine 122 to search for one or more credit offers.

With continued reference to FIG. 3, upon identifying a credit account offer associated with the merchant 102, to present to the consumer 114, the credit offer engine 122 transmits, at 310, the credit account offer to the offer interface engine 120, at the consumer's communication device 118. Alternatively, when the received location is not identified, the credit offer engine 122 may transmit a message to the consumer's communication device 114 indicating that no credit account offers are available for the received location. Or, the credit offer engine 122 may not transmit any response when no credit account offers are identified. The lack of response may be interpreted by the communication device 118 as no credit offers being available for the received location.

Next in the method 300, the offer interface engine 120 receives and displays the credit account offer to the consumer 114, at the presentation unit 208 of the communication device 118, at 312. The displayed credit account offer may include terms and conditions about the offered credit account, such as, for example, potential interest rates, annual fees, potential credit limits, rewards, discounts, etc. In addition, the displayed credit account offer includes an option for the consumer 114 to accept the offer or decline the offer.

FIG. 4 illustrates an exemplary interface 400 suitable for displaying the identified credit account offer to the consumer 114 (e.g., at 312 in the method 300, etc.). As shown, the exemplary interface 400 includes details of the credit account offer for the merchant 102, including a proposed interest rate (i.e., 7.5%), a cash-back reward (i.e., 1%), and an annual fee (i.e., no annual fee in the interface 400). In addition, the interface 400 may include a proposed credit limit (i.e., $1,500) for the new credit account. In this manner, for example, even before accepting the offer, the consumer 114 is able to understand how much he/she can spend at the merchant 102 based on the proposed credit account, as well as the other terms of the credit account. As such, the offer may enhance the consumer's shopping experience with the merchant 102. The exemplary interface 400 further includes a button 402 to accept the credit account offer, and a button 404 to decline the credit account offer. It should be appreciated that a variety of different interfaces may be employed to relay the credit account offer to the consumer 114, via the communication device 118, thereby allowing the consumer 114 to accept or decline the credit account offer, and further alter shopping behavior at the merchant 102.

Referring again to FIG. 3, at 314, the offer interface engine 120 receives either an acceptance of the credit account offer (e.g., by selection of button 402 in the interface 400, etc.) or a decline of the credit account offer (e.g., by selection of button 404, etc.) from the consumer 114. If the credit account offer is accepted by the consumer 114, the communication device 118 facilitates completion of a credit application for the new credit account, at 316. For example, the offer interface engine 120 may cause an application interface (not shown) to be displayed to the consumer 114 at the presentation unit 206 of the communication device 118, which solicits various information from the consumer 114 and which forms the content of the credit application. The consumer 114 responds by providing the solicited information. In some embodiments, at least a portion, or all, of the content of the credit account application is populated automatically, by the offer interface engine 120, from a consumer profile for the consumer 114, stored in memory 204, whereby the consumer 114 is required to enter only a portion or none of the information in order to submit the application for approval. When the application is completed, the offer interface engine 120 transmits the application (whether in total or parts thereof) to the credit offer engine 122, at 318. Further, in connection with completing the credit account application, the offer interface engine 120 may, optionally (as indicated by the dotted lines in FIG. 3), request a credit report for the consumer 114 from the credit bureau 110, at 320. The offer interface engine 120 may then incorporate the credit report in the “completed” credit account application that is transmitted to the credit offer engine 122, or direct the credit bureau 110 to provide the credit report directly thereto.

Additionally, in some embodiments, the communication device 118 may collect biometric data from the consumer 114, via an input device 208, which may be compared to a reference to permit the consumer 114 to accept the credit account offer, or which may be included in the credit account application, and/or which may be later used for authenticating the consumer 114 in connection with use of the new credit account, if approved. As an example, in connection with issuance of the new credit account (when accepted and approved), the consumer 114 may be able to select use of one of a fingerprint, a retina/face image/scan, a voice scan/recording, or a PIN entry (or others) as a required input in order to use the new credit account.

If the credit offer is declined by the consumer 114, at 314, however, the communication device 118 provides and/or displays, at 322, a coupon for use at the merchant 102. The coupon may include a discount for products at the merchant 102, which is received from the merchant 102 and/or the credit offer engine 122., thereby incentivizing the consumer 114 to still shop at the merchant 102 and to also authorize such offers in general to be presented at the communication device 118 (even through the consumer 114 may be likely to decline such offers). It should be appreciated that, in various embodiments, providing the coupon, in response to the consumer 114 declining the offer, may be omitted.

Next in the method 300, the credit offer engine 122 receives the credit account application from the communication device 114, at 324. If not ordered by the offer interface engine 120, the credit offer engine 122 may, optionally (as indicated by the dotted lines in FIG. 3), request a credit report for the consumer 114 from the credit bureau 110, at 326. The credit offer engine 122 then determines whether to approve or decline the credit account application, at 328. This may be done independently by the credit offer engine 122, or it may be done in conjunction with the credit bureau 110, or with the issuer 108 associated with the new account (e.g., based on data provided in the credit application, etc.). In addition, this may be done independent of obtaining a credit report in some embodiments. With that said, various metrics may be used to approve or decline the application such as, for example, various thresholds (e.g., credit score thresholds, etc.), income thresholds, debt amounts, employment history, etc., as defined by one or more entities including, for example, the issuer of the new account (e.g., issuer 108, etc.). Further, in making this determination, the credit offer engine 122 may verify the content contained in the credit account application (e.g., with the credit bureau 110, or with one or more third parties, etc.).

If the credit account application is approved, various other factors including, for example, credit line, etc., may be determined by the credit offer engine 122 by conventional means. For instance, the credit report may provide a credit score, and the credit offer engine 122 may apply rules for determining credit limit based on the credit score (e.g., a score of 200-400 may receive a $500 limit, a score of 400-600 may receive a $1000 limit, a score of 600-800 may receive a $3000 limit, and a score from 800-950 may receive a $7000 limit, etc.).

Further, once approved, and the terms of the new account are defined, the credit offer engine 122 (alone or in combination with issuer 108 (if not incorporated therein)) causes a credit payment account to be issued, at 330. The issued account includes a credit limit, an interest rate, and credit account payment information (e.g., credit card number, expiration date, card verification value (CCV), etc.) (broadly, credentials) that enables the consumer 114 to initiate transactions using the credit account (or otherwise use the account, depending on account type, etc.) at the merchant 102. The credit account may further include associated rewards and/or discounts that may be awarded to the consumer 112 for defined purchasing behavior. Once issued, the credentials associated with the new account are transmitted to the offer interface engine 120 (or payment application), via the communication device 118.

Upon receipt of the credentials for the new payment account, the offer interface engine 120 appends, at 332, the credit account to the payment application at the communication device 118, whereby the consumer 114 is able to fund purchase transactions with the merchant 102 through the new credit payment account. In some embodiments, the consumer 114 may be pre-approved for the new credit account. In such embodiments, the consumer 114 may simply need to accept the offer for the new account (at 314), and the new account will be appended to the consumer's payment application at the communication device 118 (at 332). Here, the consumer 114 may have previously downloaded the payment application and, in connection with registering for the application, activated (or deactivated) push notifications. When activated, the push notifications allow certain data to be pulled from the communication device (e.g., from the consumer profile at the communication device 118, etc.) to allow for the preapproval consideration.

FIG. 5 illustrates an exemplary payment application interface 500, which may be displayed at the presentation unit 206 of the communication device 118, after the payment account is appended to the payment application. As shown, the interface 500 includes a tab 502 that, when activated, displays a list of available payment accounts in the payment application including, in the illustrated interface 500, the new account issued to the consumer 114, i.e., “Merchant A Rewards” (which is selected, as indicated by the check mark). Details for the new account (as selected from the available payment accounts in the payment application) are also provided in the interface 500, for example, the account owner's name, the account number, the expiration date for the new account, and the CCV for the new account. In some embodiments, payment application interfaces may include additional features, such as a barcodes or other indicators (or other signals) that may be used to scan (or transmit) payment information in order to initiate transactions using the selected payment account, etc. In use, as described above with reference to FIG. 1, to initiate a payment transaction, for example, the consumer 114 selects the new account in interface 500 and presents the communication device 118 to the merchant 102 and, in particular, to the POS terminal at the merchant 102. In doing so, the communication device 118 communicates the credentials associated with the new account to the POS terminal for funding the purchase transaction.

In other embodiments, the credit payment account may be provided to the consumer 114 and/or the communication device 118 in another manner, apart from a payment application, whereby the consumer 114 is still able to initiate purchase transactions with the new account, while at the merchant 102.

With further reference to FIG. 3, alternatively in the method 300, if the credit account application is declined, the offer interface engine 120 is informed and causes a decline message to display at the communication device 114, at 334, for review by the consumer 114. In addition, the offer interface engine 120 further provides and/or displays, at 322, a coupon for use at the merchant 102. The coupon may be provided, for example, from the credit offer engine 122 along with the notification that the credit account application is declined.

It should be appreciated that in the method 300, each of the operations from receipt of the location 116, at 306 in the method 300, until the credit account is issued, at 330, is completed within a time period, whereby the consumer 114 is permitted to utilize the new account, when issued, which was applied for while at the location 116 of the merchant 102. More generally, these operations of the method 300 are completed within a predefined interval of the transmittal of the detected location to the credit offer engine 122, where the predefined interval is less than, for example, one day, one hour, ten minutes, five minutes, etc. As such, consumers are permitted to accept an offer for a new payment account at a front end of a shopping experience at the merchant 102, while having confidence that the applied for account will be available to fund purchase transactions at completion of the shopping experience.

In view of the above, the systems and methods herein may enable consumers to open credit accounts associated with merchants by responding to offers pushed to their communication devices upon entering the premises of the merchants. In this manner, the merchants are permitted to cause credit account offers, for merchant-specific accounts, to be delivered to consumers as they enter the merchant locations, and provide the offered accounts to the consumers at the merchants, whereby the consumers will be able to spend funds generally unavailable to the consumers prior to their presence at the merchants. The merchants therefore enable the consumers with purchasing power specific to the merchants, and readily usable while located at the merchants.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) detecting a location associated with a merchant; (b) transmitting the detected location to a credit offer engine; (c) identifying an offer for a credit account associated with a merchant based on a location received from a communication device associated with a consumer; (d) receiving the credit account offer associated with the merchant, based on the detected location; (e) receiving an acceptance from the consumer in response to the credit account offer; (f) transmitting, by the computing device, a credit application to the credit offer engine for a credit account associated with the credit account offer; (g) causing a credit account to be issued and transmitted to a payment application associated with the consumer, in response to the credit application; and (g) upon approval of the credit application, receiving and appending, by the computing device, credentials associated with the credit account to the payment application of the consumer, whereby the credit account is usable to fund a payment transaction with the merchant.

As will also be appreciated based on the foregoing specification, the above-described embodiments of the disclosure may be implemented using computer programming or engineering techniques including computer software, firmware, hardware or any combination or subset thereof, wherein the technical effect may be achieved by: (a) identifying an offer for a credit account associated with a merchant, from multiple different offers, based on a location received from a communication device associated with a consumer; (b) transmitting the identified offer for the credit account to the communication device associated with the consumer; (c) receiving a credit application for the consumer in response to the identified offer; and (d) causing a credit account to be issued and transmitted to a payment application associated with the consumer, in response to the credit application, whereby the credit account is usable to fund a payment transaction with the merchant.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in offering a credit account to a consumer based on the consumer being at a location of a merchant associated with the credit account, the method comprising:
detecting, by the computing device, a location associated with a merchant;
transmitting, by the computing device, the detected location to a credit offer engine;
receiving, by the computing device, a credit account offer associated with the merchant, based on the detected location;
receiving, by the computing device, an acceptance from the consumer in response to the credit account offer;
transmitting, by the computing device, a credit application to the credit offer engine for a credit account associated with the credit account offer; and
upon approval of the credit application, receiving and appending, by the computing device, credentials associated with the credit account to a payment application of the consumer, whereby the credit account is usable to fund a payment transaction with the merchant.

2. The computer-implemented method of claim 1, wherein detecting a location associated with the merchant includes detecting a geographic location of the computing device.

3. The computer-implemented method of claim 1, wherein detecting a location associated with the merchant includes detecting a presence and/or an entry of the computing device within/into a region associated with the merchant.

4. The computer-implemented method of claim 1, wherein detecting a location associated with the merchant includes detecting a signal indicative of the merchant; and
wherein transmitting the detected location includes transmitting a merchant identifier to the credit offer engine.

5. The computer-implemented method of claim 4, wherein the signal indicative of the merchant includes at least one of a Wi-Fi signal, a radio frequency identification (RFID) signal, a cellular triangulation signal, and a Bluetooth signal associated with the merchant.

6. The computer-implemented method of claim 1, wherein receiving an acceptance from the consumer includes receiving biometric data associated with the consumer; and
further comprising authenticating the biometric data, for the consumer, prior to transmitting the credit application.

7. The computer-implemented method of claim 6, wherein the biometric data associated with the consumer includes at least one of a fingerprint image, a retina image, and a voice recording.

8. The computer-implemented method of claim 1, further comprising populating, by the computing device, at least a portion of the credit application from a consumer profile stored in the computing device.

9. The computer-implemented method of claim 1, further comprising communicating, by the computing device, the credentials to a point-of-sale (POS) terminal associated with the merchant for funding a payment transaction with the merchant.

10. The computer-implemented method of claim 9, further comprising, prior to communicating the credentials to the POS terminal:
receiving, by the computing device, biometric data associated with the consumer; and
authenticating the received biometric data.

11. The computer-implemented method of claim 1, wherein receiving and appending credentials associated with the credit account to a payment application includes appending the credentials to the payment application within a predefined interval of transmitting the detected location to the credit offer engine; and
wherein the predefined interval is less than ten minutes.

12. The computer-implemented method of claim 1, further comprising, upon decline of the credit application, receiving and displaying, by the computing device, a coupon usable in a payment transaction with the merchant.

13. A computer-implemented method for use in offering credit accounts at merchant locations, the method comprising:
identifying, by a computing device, an offer for a credit account associated with a merchant, from multiple different offers, based on a location received from a communication device associated with a consumer;
transmitting, by the computing device, the identified offer for the credit account to the communication device associated with the consumer;
receiving, by the computing device, a credit application for the consumer in response to the identified offer; and
causing, by the computing device, a credit account to be issued and transmitted to a payment application associated with the consumer, in response to the credit application, whereby the credit account is usable to fund a payment transaction with the merchant.

14. The computer-implemented method of claim 13, wherein the location received from the communication device includes a merchant identifier, based upon which, at least in part, the offer is identified.

15. The computer-implemented method of claim 13, wherein the location includes a geographic location received from the communication device associated with the consumer; and
further comprising determining whether the location is within a merchant location.

16. The computer-implemented method of claim 15, wherein the merchant location is defined by a geo-fence.

17. The computer-implemented method of claim 15, further comprising:
requesting, by the computing device, a credit report for the consumer from a credit bureau based at least in part on the credit application;
receiving the credit report from the credit bureau; and
approving the credit application when the credit report satisfies at least one threshold;
wherein causing a credit account to be issued includes causing the credit account to be issued when the credit application is approved.

18. The computer-implemented method of claim 15, further comprising requesting, by the computing device, approval of the credit application from an issuer of the new credit account; and
wherein causing a credit account to be issued includes causing the credit account to be issued when the credit application is approved

19. The computer-implemented method of claim 13, wherein causing a credit account to be issued and transmitted to a payment application includes appending credentials for the credit account to the payment application associated with the consumer.

20. A non-transitory computer readable storage media including computer executable instructions for offering credit accounts to consumers at merchant locations, which when executed by at least one processor, cause the at least one processor to:
receive an offer for a new credit account, associated with a merchant, at a communication device when the communication device is located at the merchant;
generate a credit application for the new credit account; and
when the credit application is approved, receive and append credentials associated with the new credit account to a payment application at the communication device, whereby the new credit account is usable via the communication device to fund a payment transaction with the merchant.
